(19) United States
(12) Patent Application Publication
(10) Pub. No.: US 2017/0104748 A1
(43) Pub. Date: Apr. 13, 2017

(54) SYSTEM AND METHOD FOR MANAGING NETWORK ACCESS WITH A CERTIFICATE HAVING SOFT EXPIRATION

(71) Applicant: Cloudpath Networks, Inc., Wesminster, CO (US)

(72) Inventor: Kevin Lee Koster, Westminster, CO (US)

(21) Appl. No.: 14/882,323

(22) Filed: Oct. 13, 2015

(51) Int. Cl. H04L 29/06; H04L 9/32

(52) U.S. Cl. CPC H04L 63/0823; H04L 9/3268; H04L 63/0853; H04L 63/0892

(57) ABSTRACT

Provided is a system and method for managing network access with a Certificate having Soft Expiration. The system includes an Authentication System structured and arranged to receive from a User by way of a first device having at least one processor, a request for certificate based network access, the request including a Certificate having a Soft Expiration Date. A validation hardware system having at least one processor and being in communication with the authentication hardware system is structured and arranged to receive a request for validation of the Certificate, the validation hardware system evaluating the Certificate having the Soft Expiration Date to a current date by querying a Certificate invalidity source to provide a positive or negative evaluation of the Certificate. In response to a positive evaluation of the soft expiration date to the current date, the authentication hardware system permitting certificate based network access to the user's first device. In response to a negative evaluation of the soft expiration date to the current date the authentication system blocking at least a portion of network access to the user's first device, and providing the User an opportunity to reset the Soft Expiration. An associated method of use is also provided.

### FIELD OF THE INVENTION

The present invention relates generally to systems and methods for establishing authentication of Users of computer networks, and more specifically to systems and methods for managing network access based on a digital Certificate having a Soft Expiration provided to Users of secured networks, the Certificates identifying the Users and also controlling, at least in part, the scope of network access afforded to the User, the Soft Expiration being used to validate or invalidate the request for access separate and apart from a Certificate revocation list.

### BACKGROUND

In the physical world, individual persons are able to assess one another by sight, hearing and an accounting of physical attributes. Drivers' licenses, passports and other regulated documents provide verified accountings of attributes that permit individuals to validate who they are, or for others to validate who an individual says he or she is.

Fingerprints, retinal pattern, breath and DNA among other attributes are understood and recognized to be highly individualistic and are widely accepted and used to verify identity. But these attributes are physical and tied to a physical world.

Computers have become commonplace and highly integrated in nearly all aspects of modern life—transcending the bounds of professional and social spaces, computers are a prominent fixture in the workplace, in the home, as mobile devices and in many other places and arenas of daily life and modern existence.

Increasingly individuals are representing themselves in the cyber world of computer systems and computer networks, where digital information in the elemental form of binary data is entirely ignorant of physicality. A critical problem in cyberspace is knowing with whom you are dealing—in short, at the present time there is no precise way to determine the identity of a person in digital space. Friends, families, colleagues may use a common computer, share passwords, or even pretend to be people they are not. Sometimes these actions are benign—sometimes they are not.

Traditionally, different systems establish individualized, but similar signup and login procedures to collect information directly from users to establish user identities, passwords and other information in the effort to establish at least a notion of an identity for a user.

A typical person over the age of ten in a modern household with access to computer resources may have a number of user accounts, each with a user name and password as well as perhaps additional security measures such as pin numbers, security images, test questions, and the like.

But the redundancy of such systems, especially where use of a system is occasional or only desired for a brief interaction leads to many problems. Users struggling to remember passwords default to the use of simple phrase, such as “password”, “opensaysme”, “abcdgoldfish”, “0p3n4m3” or other simplistic phrases that are easily compromised. Although advances in data storage have increased dramatically in recent years there are still costs involved in archiving data—and establishing a user account and maintaining the data records for such an account may be costly for a system where the high percentage of users never return.

Indeed, in some cases when a user is faced with forgetting his or her prior login information or being unsure if he or she even has an existing identity, the user may opt to create a new identity rather than try and recover the old identity—an action that further leads to increases in archived data, increased storage requirements, potential maintenance issues, and of course costs in terms of time, energy and money.

As computers are often used in a commercial setting such as a business, organization or secured network (hereinafter “business”), there are often very legitimate desires by that business to know who is accessing their network. In addition, in many instances it is highly desired by a business or organization to not only know who is using their system, but also to control the type of equipment that is used with their system.

In other situations, businesses may commercialize network access—such as hotels, conference centers, event centers, shopping centers, restaurants, coffee shops or other establishments. In some cases network access may be provided free of charge during the user's stay or use of the facility. But here too are many potential challenges in striving to ensure that access is indeed only permitted during the user's stay or use of the facility, and for the user, does he or she need a new account with password time after time?

Digital certificates, also known as public key certificates, are electronic documents that bind a digital signature (a mathematical schema for demonstrating authenticity) to a key, such as a public key, that is tied to an identity. More simply put, digital certificates are electronic documents that are offered to prove or verify the identity of the user. Typically a digital certificate is issued by a certificate authority (CA) that has performed or established some threshold of information to assert that the party to whom the certificate is issued is indeed the party he or she reports to be.

In addition to identifying a person, a digital certificate may also include additional information, such as the level of authorization that should be afforded to the holder of the certificate, the duration of validity for the certificate, the user's real name, the user's alternative name, the intermediate certificate authority who issued the certificate, or other such information pertinent to establishing both the identity of the user of the digital certificate as well as the veracity of the root certificate authority ultimately responsible for the apparent authority vested in the digital certificate.

Indeed, digital certificates can and often do provide a great deal of simplicity in authenticating a user as the user has clearly established him or herself in some way that is sufficient for a certificate authority to provide the digital certificate. Relying on a digital certificate can ease a network's reliance on parties having previously established or contemporaneously establishing a local identity—a savings both in terms of time for the user and costs associated with the overhead and storage of the user identity for the local network.

It should also be noted that in most cases, a user, requesting access to resources, who is providing a name and password is in essence already connected to the network, and as such there is a potential security risk.

The Open System Interconnection model, also referred to as the Open Source Interconnection model or more simply the OSI model, is a product of the Open System Interconnection effort at the International Organization for Standardization, and more specifically is a prescription of characterizing and standardizing the functions of a communication system in terms of seven abstraction layers of concentric organization—Layer 1 the physical layer, Layer 2 the data link layer, Layer 3 the network layer, Layer 4 the transport layer, Layer 5 the session layer, Layer 6 the presentation layer, and Layer 7 the application layer.

TCP/IP based network communication is established at Layer 3, the network layer. By contrast, when a user is presented with a login screen requesting a User Name and Password, that interaction is occurring at the Application layer 7. Moreover, because the User has actually established connection through the Layers 1-6, there is a possibility that errant code and or configuration of network devices could permit a user to gain unwarranted access to some if not all resources without actually providing a proper username and password.

The use of certificates in proving user identity in and among networked resources is not entirely new. The prior art reference of Appiah US 2010/0077208 teaches an authentication service configured to authenticate User Credentials and generate an authentication certificate based on the User Credentials and the System Identifier FOR subsequent authentication to a Data Center. The prior art reference of Borneman U.S. Pat. No. 7,953,979 teaches a system and method to establish trust so that a trusted third party may then provide Signed Certificates to verify Trust, i.e. the Master System is delegating authority.

The prior art reference of Guo US 2010/0247055 is teaching device specific authentication for website access (Layer 7)—a user with a device known to an account authority service can obtain a security token via a communications network to present to another entity via a communications network as proof of identity. The prior art reference of Liu US 2010/0154046 is teaching a single sign-on methodology across web sites and services (Layer 7). The prior art reference of Norefors US 2006/0094403 teaches a method of obtaining network service by using a phone having existing telecommunications service and a PC connecting to a Web Server (Layer 7) which directs a One Time Password to be sent via Short Message Service, also known as SMS, to the user's phone read by the user and provided back to the Web Server via the PC (Layer 7).

Still further, the prior art reference of Benantar US 2002/0144119, teaches a User obtaining a digital certificate from a Certificate Authority and the public and private certificates being loaded to a keystore of a Single Sign On system. The Single Sign On system uses the digital certificate to gate access to legacy applications (Layer 7). And of course it is clear that these legacy applications are within the Benantar network.

However, in all of these instances the use of the Certificate for identification or signing purposes is occurring at Layer 7—the Application layer. In all of these references, the underlying network connections have already been established and are being used. Moreover, although the use of a Digital certificate is being taught as a way of potentially increasing user authentication all of these references fall short of any attempt to further safeguard the original network connection. While the digital certificate can certainly be used for access to network resources and that is highly desirable, there are underlying security issues that these references fail to address.

Indeed as digital certificates are most commonly used as attestations of trust, i.e., the signing of documents, messages, applications and the like, as well as the verification that another party is who he or she says they are, there is typically a great deal of concern on who should receive a certificate—has the user been properly vetted, what resources should he or she have, how long should the certificate last, where and when can the certificate be used, etc. . . . .

While these issues are extremely relevant in some settings—as with the prior art references above—they are not relevant in all settings. Indeed the use of certificates can significantly increase security in accessing secured networks and network resources, but even as this element of increased security is achieved the use of certificates may simplify the overhead of keeping track of who has access to what and when, as well as other matters. But the prior art materials presently known have not addressed these issues.

Hence there is a need for a method and system that is capable of overcoming one or more of the above identified challenges.

### SUMMARY OF THE INVENTION

Our invention solves the problems of the prior art by providing novel systems and methods for providing network access management based on a Certificate having Soft Expiration.

In particular, and by way of example only, according to one embodiment of the present invention, provided is a method of managing network access based on a soft expiration date for a Certificate including: generating, by a Certificate generation system having a processor, a Certificate having an embedded expiration date; establishing for the Certificate a Soft Expiration Date occurring before the embedded expiration date; providing the Certificate having the Soft Expiration Date to a User Device having a processor, the User Device distinct from the Certificate generation system, the certificate for certificate based network access on a secured wireless network; receiving by an authentication device, a request for wireless network access upon the secured wireless network from the user device, the request providing the Certificate having the Soft Expiration Date; evaluating the soft expiration date of the Certificate having the Soft Expiration date to a current date; in response to a positive evaluation of the soft expiration date to the current date, validating the Certificate having the Soft Expiration Date provided in the request and permitting certificate based network access to the user device; and in response to a negative evaluation of the soft expiration date to the current date, restricting the Certificate having the Soft Expiration Date provided with the request and blocking at least a portion of network access to the user device.

For another embodiment, provided is a system for managing certificate based network access based on a soft expiration date for a Certificate including: an authentication hardware system structured and arranged to receive from a User by way of a first device having at least one processor, a request for certificate based network access, the request including a Certificate having a Soft Expiration Date; a validation hardware system having at least one processor and being in communication with the authentication hardware system and structured and arranged to receive a request for validation of the Certificate, the validation hardware system evaluating the Certificate having the Soft Expiration Date to a current date by querying a Certificate invalidity source to provide a positive or negative evaluation of the Certificate; wherein in response to a positive evaluation of the soft expiration date to the current date the authentication hardware system permitting certificate based network access to the user's first device and in response to a negative evaluation of the soft expiration date to the current date the authentication system blocking at least a portion of network access to the user's first device.

Further, in yet another embodiment provided is a non-transitory machine readable medium on which is stored a computer program for managing certificate based network access on a soft expiration date for a Certificate provided to a user, the computer program including instructions which when executed by a computer system having at least one processor performs the steps of: receiving by an authentication device, a request for wireless network access upon the secured wireless network from the user device, the request providing the Certificate having a Soft Expiration Date, the Certificate having the Soft Expiration Date previously provided to the user device by a certificate generation system other than the user device, the Soft Expiration Date of the Certificate established to occur before an embedded expiration date within the Certificate having the Soft Expiration Date; evaluating the soft expiration date of the Certificate having the Soft Expiration date to a current date; in response to a positive evaluation of the soft expiration date to the current date, validating the Certificate having the Soft Expiration Date provided in the request and permitting certificate based network access to the user device; and in response to a negative evaluation of the soft expiration date to the current date, restricting the Certificate having the Soft Expiration Date provided with the request and blocking at least a portion of network access to the user device.

Still, in yet another embodiment, provided is a non-transitory machine readable medium on which is stored a computer program including instructions to adapt a computer system having at least one processor to provide certificate based network access based on a Certificate having a soft expiration date previously provided to a user including: a receiver module operatively associated with an input device for receiving a request for certificate based network access from a user by way of a first device having at least one processor, the request providing the Certificate having the Soft Expiration Date previously provided to the user device by a certificate generation system other than the user device, the Soft Expiration Date of the Certificate established to occur before an embedded expiration date within the Certificate having the Soft Expiration Date; an evaluation module for evaluating the soft expiration date of the Certificate to provide a positive or negative evaluation of the request; in response to a positive evaluation of the soft expiration date to the current date, validating the Certificate having the Soft Expiration Date provided in the request and permitting certificate based network access to the user device; and in response to a negative evaluation of the soft expiration date to the current date, restricting the Certificate having the Soft Expiration Date provided with the request and blocking at least a portion of network access to the user device.

### BRIEF DESCRIPTION OF THE DRAWINGS AND SUPPORTING MATERIALS

FIG. 1 illustrates a high level diagram of a system for managing network access based on a certificate having soft expiration in accordance with at least one embodiment;

FIG. 2 illustrates a table of Soft Expirations for Certificates in accordance with at least one embodiment;

FIG. 3 illustrates a flow diagram for a managing network access based on a certificate having soft expiration in accordance with at least one embodiment;

FIG. 4 is a refined version of FIG. 1 further illustrating the managed access based on a certificate having soft expiration for a request by a first user in accordance with at least one embodiment;

FIG. 5 is a refined version of FIG. 1 further illustrating the managed access based on a certificate having soft expiration for a request by a second user in accordance with at least one embodiment;

FIG. 6 is a refined version of FIG. 1 further illustrating the managed access based on a certificate having soft expiration for a request by a third user in accordance with at least one embodiment;

FIG. 7 is a refined version of FIG. 1 further illustrating the managed access based on a certificate having soft expiration for a request by a fourth user in accordance with at least one embodiment; and

FIG. 8 is a high level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for managing network access with certificates, and more specifically managing network access by way of a Certificate having a soft expiration date. Thus although the instrumentalities described herein are for the convenience of explanation shown and described with respect to exemplary embodiments, it will be understood and appreciated that the principles herein may be applied equally in other types of systems and methods involving digital certificate with or without specifically involving managing network access with the use of a Certificate.

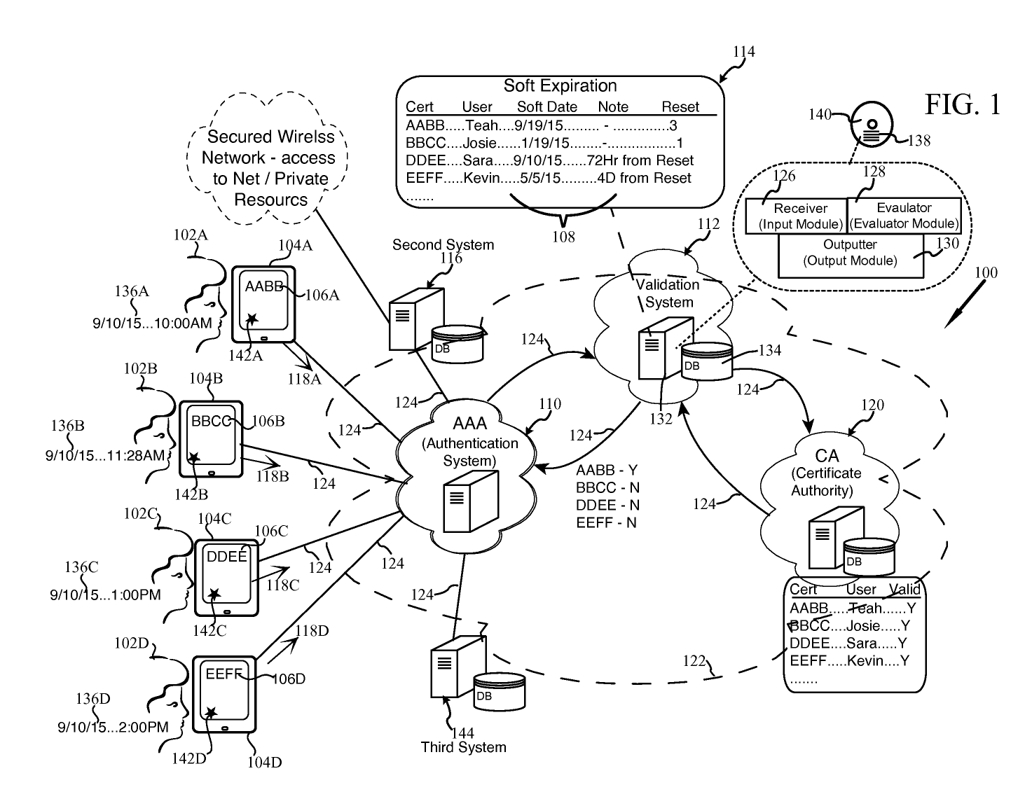

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

Various embodiments presented herein are descriptive of apparatus, systems, articles of manufacturer, or the like for systems and methods involving providing a certificate by way of a browser extension. In some embodiments, an interface, application browser, window or the like may be provided that allows the user of the computing device to direct behavior of the computing device.

Moreover, some portions of the detailed description that follows are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated. Those skilled in the art will appreciate that these signals are commonly referred to as bits, values, element numbers or other clearly identifiable components.

It is of course understood and appreciated that all of these terms are associated with appropriate physical quantities and are merely convenient labels applied to these physical quantifies. Moreover, it is appreciated that throughout the following description, the use of terms such as “processing” or “evaluating” or “receiving” or “outputting” or the like, refer to the action and processor of a computer system or similar electronic computing device that manipulates and transforms data represented as physical (electrical) quantities within the computer system's memories into other data similarly represented as physical quantities within the computer system's memories.

The present invention also relates to apparatus for performing the operations herein described. This apparatus may be specifically constructed for the required purposes as are further described below, or the apparatus may be a general purpose computer selectively adapted or reconfigured by one or more computer programs stored in the computer upon computer readable storage medium suitable for storing electronic instructions.

To further assist in the following description, the following defined terms are provided.

“Certificate Authority”—the entity that issues digital Certificates. Commercial Certificate Authorities often use a combination of techniques including government and private information bureaus, credit card based payment infrastructure, and other measures in an effort to verify and assure that public key contained in the Certificate belongs to the person, organization, server or other entity noted in the Certificate. Moreover, Certificate Authorities not only issue Certificates, but are also used to verify the validity of the holder of the Certificate. Revocation of Certificates is handled by a Certificate Registration List (“CRL”) that provides serial numbers of revoked Certificates. Typically, CRL's are provided at defined intervals.

“Authentication System”—The system to which Users connect when requesting access to a secured system or resource, such as an active directory based on the determined validity of a presented Certificate. For at least one embodiment the Authentication System is an Authentication, Authorization and Accounting (“AAA”) system such as a RADIUS server.

“Second System/Secured Wireless Network”—the network or application resource to which a User may connect or engage based on the User having an appropriate Certificate.

“Validation System”—the entity that evaluates Soft Expiration date of the Certificate to determine the validation status of the Certificate. As is set forth below, it is an aspect of the present invention to validate or invalidate a Certificate based on the Soft Expiration date of the Certificate, generally in near real time and without the use of a CRL. For at least one embodiment the Validation System and the Authentication System are one and the same system.

“First Device”—the computing device that is used by the person requesting a Certificate. As is further set forth below, it is an aspect of the present invention to validate the device as proper in determining whether or not to provide the requesting person with a Certificate.

“Device Trait”—a physical aspect of the device and/or a software aspect of the device which is an identifiable element of the device, such as, but not limited to, device ID number, device serial number, device type, manufacturer, software version, software ID, an application, digital ID, MAC address, or other similar element. It may also be the presence of or perhaps the absence of a discrete file, and/or the response to a private key or public key challenge. Typically it is provided as a component of the request for the Certificate, directly or as perhaps metadata, but it also may be determined by querying the requesting device.

“User”—typically a person or at the very least a computing device used by a person who is known to the Authentication System, or an administration system that is in communication with the Authentication system in the sense that the he or she has established a User account by providing a threshold of data, e.g. attributes, to identify themselves. Typically it is expected that the Users' interactions with the Authentication System or the related administration system will also serve to establish additional Attributes about themselves.

“Certificate”—also referred to as a digital Certificate, this is a credential that is usable for authentication to the Second System. In at least one embodiment, the Certificate is an X.509 digital Certificate.

“Soft Expiration”—also referred to as a Soft Expiration Date, is an adjustable/resettable date of expiration for accepting the certificate. This date is intended to be different from the true expiration date that is encoded or embedded into the Certificate when provided. In varying embodiments the Certificate may be accepted on/through the Soft Expiration Date, or up to the Soft Expiration Date.

“Certificate Trait”—elements of data that are encoded or embedded into or associated with the Certificate. Certificate Trait may include but are not limited to, a root Certificate Authority, intermediate Certificate Authority, time period, common name, subject name, subject's alternative name.

“Secured Network Access”—the fundamental OSI Layer 2-3 connection between the User's computing system and Second System, the network connection established without the need for the User to provide a user name, password, or other element, rather the connection is fundamentally based on the User having an appropriate Certificate. Moreover it is the first communication link between the User's Device and the Second System, and is not a subsequent connection from a device the User's computing system has already connected to at Layer 2-3. In a wireless network setting, the Certificate is automatically provided to the Second System's SSID and the connection is established. Without the Certificate, no secured network access is established with the Second System.

“Secured Application Access”—this is OSI Layer 7 access to an applicant based on the Certificate. Moreover, Secured Application Access is understood and appreciated to be distinct from Secured Network Access.

“Characteristic”—an element of data that is distinct from the Certificate and/or Certificate Trait, such as but not strictly limited to the time, date, IP address, or system hardware address, that may be readily determined from the request for network access made by a User in connection with the presentation of the Users Certificate. Moreover, the Characteristic may be an element that is provided directly by the User and is a part of the submitted request, i.e., the User's IP or MAC address, or it may be an element that is determined by the Authentication System and/or the Validation System, i.e., the time the User's request is received.

With respect to the above defined terms, it is understood and appreciated that for at least one embodiment, each module or system is implemented as a collection of independent electronic circuits packaged as a unit upon a printed circuit board or as a chip attached to a circuit board or other element of a computer so as to provide a basic function within a computer. In varying embodiments, one or more modules may also be implemented as software that adapts a computer to perform a specific task or basic function as part of a greater whole. Further still, in yet other embodiments one or more modules may be provided by a mix of both software and independent electronic circuits.

To briefly summarize, provided is a system and method for managing network access based on a Certificate with a Soft Expiration. In general a User is provided with a Certificate that he or she will use for access to a secured network access to one or more systems and sources. When a User holding such a Certificate makes a request for network access, the Authentication System receives the Certificate and rather than the traditional approach of determining validity based on the Certificate's expiration date, OCSP, and/or a CRL, the Soft Expiration is evaluated. More specifically, the Certificate may be established with a very long life span such that it is very likely that the Certificate is technically valid, however the decision to accept the certificate as valid is not based on the actual expiration date but the Soft Expiration associated therewith. And, as will be discussed below, the Soft Expiration can be reset, thereby permitting continued use of the Certificate and managed network access for the User.

This summary may be more fully appreciated with the respect to the following description and accompanying figures.

Turning now to the drawings, and more specifically, FIG. 1, there is shown a high level diagram of an embodiment of a system for managing network access based on a Certificate with Soft Expiration, e.g., CSE 100, for network access to Users 102 having a First Device 104 and a Certificate 106 having a Soft Expiration 108.

CSE 100 also includes at least an Authentication System 110, a Validation system 112, having a Soft Expiration record 114, and a Second System 116 to which the Users 102 desire access. As set forth below, in varying embodiments each of these systems may be a separate system within CSE 100, or one or more of these system may be combined with one another. In addition, as will be further discussed below, for at least one embodiment the Soft Expiration 108 is specified within the Certificate 106 itself, such that a separate Soft Expiration record 114 may not required for operation of CBP 100, or at least some of the Certificates 106 used within CSE 100.

With respect to each device or system, whether the Users 102 First Device 104, the Authentication System 110, the Validation System 112, the Second System 116, or other device or system as discussed below, each is understood and appreciated to be a computing device including one or more microprocessors, memory, input and output devices, and the like which are adapted by hardware and/or software to permit data exchange over a network, and more specifically browser based data exchange.

With respect to FIG. 1, for the present example, there are shown a plurality of Users 102, of which Users 102A, 102B, 102C, and 102D are exemplary. Each User 102A-102D has a corresponding User Device, hereinafter “UD” or first device 104A-104D, which is understood and appreciated to be a computing device having at least one processor.

Also shown in FIG. 1 is a Second System 116 to which the network access is granted upon validation of the Certificate 106 based on the Soft Expiration 108. As suggested by the illustration of FIG. 1, the Authentication System 110 and the Second System 116 may indeed be separate systems. However, it should also be appreciated that the Authentication System 110 and the Second System 116 may both be varying parts of a greater whole—such as a company, business, or other entity that provides the Authentication System 110 as a way to authenticate it's Users 102, and the Second System 116 is the private network to which the authenticated Users 102 are then given network access.

When a User 102 desires to access the Second System 116, he or she makes this request for access to the Authentication System 110, the request 118 including the Certificate 106. As will be further understood below, access to the Second System 116 is dependent upon acceptance of the Certificate 106 with Soft Expiration 108. If the Certificate 106 is determined to be invalid, no access to the Second System 116 is provided. For at least one embodiment the Second System 116 is a Secure Certificate based wireless network, such that only Users 102 who have a valid Certificate 106 with Soft Expiration 108 may enjoy access to this secured wireless network. There are many instances where the Secure Wireless Network Access of the Second System 116 may be the only option for network access, such as, but not limited to a hotel, resort, coffee shop, ship, aircraft or other environment where there may be no other network option.

As is further described below, the User may be provided with an opportunity to renew the Soft Expiration 108 of the Certificate 106, but this is an action performed without access involving the Second System 116. Moreover, it is an all or nothing Certificate based access with respect to the Second System 116.

As used herein, the term “network access” is understood and appreciated to be the ability of a User 102 to make use of the resources of Second System 116. This may include for example, but is not limited to, the use of applications, access to data, and connectivity to other systems and Users 102 within the Second System 116 as well as other public and private systems.

For at least one embodiment, Certificates 106 are provided by one or more Certificate Authority, of which Certificate Authority 120 is exemplary. As shown, Certificate Authority 120 has a database that includes serial numbers for Certificates 106A, 106B, 106C and 106D assigned respectively to exemplary Users 102A, 102B and 102C. As all of these Certificates are shown to be valid, none of these Certificate serial numbers will exist in a CRL provided by Certificate Authority 120.

There is also a Validation System 112 that is in communication with the Authentication System 110. The Validation System 112 is structured and arranged to receive a request for validation of the Certificate 106 when a User requests access and provides his or her Certificate 106. It is understood and appreciated that each Certificate 106 is static once issued, which is to say that while each Certificate 106 will typically include specific information such as, but not limited to, a serial number, a subject or intended user, the signature algorithm, the issuer, valid from date, valid to date, certificate purpose, public key, and perhaps other data, none of these data elements can be modified without inherently destroying the Certificate 106.

As such the Soft Expiration 108 for each Certificate 106 is not generally an element of the Certificate 106. For at least one embodiment, there is a pseudo exception for this—wherein one of the typical data fields of the Certificate 106 is used to notate each period of permitted use, such as 72 hours or 3 days. When such a certificate 106 is presented and this field value is determined, this field value is used from the last date of use whether the Soft Expiration 108 is still valid, i.e., is the request within 72 hours or 3 days from the first request of this particular period—if not then the User must renew, but if yes, then access is permitted.

For at least one embodiment, the Validation System 112 has a record 114 of Soft Expirations 108 (e.g., soft expiration dates) for each certificate 106. In varying embodiments, this record 114 of Soft Expirations 108 may be a component integrated with the Validation System 112, or a remote database to which the Validation System 112 has access rights when and as needed.

Moreover, the record 114 provides correlated records regarding the Users 102 known to CSE 100, their Certificates 106 and their Soft Expirations 108. This record 114 may also record additional data such as, but not limited to, the initial date/time of use of the Certificate, the last date/time of use for the Certificate, the number of renewals for the Soft Expiration 108 that have been achieved, the type of first device associated with the Certificate 106, the MAC address of the first device that last submitted the request, etc. . . . .

In varying embodiments, one or more of the elements of CSE 100 may be directly connected to one another, if not integrated with each other, but it is understood and appreciated that in most instances the incorporation of the Internet 122 as a common means of communication and information exchange is within the scope of the present invention.

It is also to be understood and appreciated that the elements of the CSE 100 need not maintain continual communication links 124. In other words, Users 102 may log on or off, and thus establish a link to Authentication System 110 and subsequently Second System 116, the Second System 116 may be on or off line at different times for different reasons, the Authentication System 110 may be on or off line at different times and for different reasons, and even the Validation System 112 and/or the Certificate Authority 120 may be on or off line at different times and for different reasons. However, in general it is understood and appreciated that for expected operation either the elements as shown or suitable substitutions are understood and appreciated to be available for expected operation of CSE 100.

In at least one embodiment, the Validation System 112, the Authentication System 110, and the Certificate Authority 120 are distinct systems, each understood to be a computing device including microprocessors, memory and the like which are adapted by hardware or software to permit data exchange over a network.

For at least one alternative embodiment, the Validation System 112 is an incorporated part or component of the Authentication System 110. For yet another alternative embodiment, the Validation System 112 is an incorporated part or component of the Certificate Authority 120.

In addition, for at least one embodiment, the Validation System 112 as a physical computer system 132 (including at least one microprocessor, memory, I/O device(s), and the like), including a database 134 for maintaining the Soft Expiration records 114, is at least in part adapted to provide the Validation System 112 in part by a receiver module 126, an evaluator module 128 and an output module 130. The receiver module 126 is structured and arranged to receive the certificate 106, or at the very least data sufficient to identify the certificate 106 as an element of the request 118. The receiver module 126 may also receive at least one characteristic 136 of the request 118, such as but not limited to the date and time of the request 118.

This Characteristic 136 may be provided by the Authentication System 110 or the receiver module 126 may self determine the Characteristic 136, such as retrieving the current time and date associated with the request 118. In addition to date and time, for yet other embodiments, the Characteristics 136 may also include data elements such as browser string agent so as to identify the type of web browser being used that may in turn indicate the type of First Device 104.

The evaluator module 128 is structured and arranged to evaluate the Soft Expiration 108 associated with the Certificate 106 provided with the request 118. In general, the evaluation of the Soft Expiration 108 of the Certificate 106 provided with the request 118 involves review of the soft expiration record 114. The output module 130 provides the evaluation of the Soft Expiration 108 to the Authentication system 110 as to the Certificate 106 being valid or restricted based on the Soft Expiration 108.

With respect to CSE 100, it is understood and appreciated that in varying embodiments, the elements, e.g., receiver module 126, the evaluator module 128 and the output module 130 may be provided as software routines, hardware elements and/or combinations thereof. Although shown distinctly for ease of illustration and discussion, in varying embodiments, it is understood and appreciated that one or more of these elements may be combined and/or further subdivided into a number of sub-elements or sub-modules.

With respect to FIG. 1, the elements of the receiver module 126, the evaluator module 128 and the output module 130 are conceptually illustrated in the context of an embodiment for a computer program 138. Such a computer program 138 can be provided upon a non-transitory computer readable media, such as an optical disc 140, or USB drive (not shown), having encoded thereto an embodiment of a program for managing network access with a Certificate 106 having Soft Expiration 108.

The computer executable instructions for computer program 138 are provided to Validation System 112, i.e. computer system 132. During operation of CSE 100 the computer program 138 for managing network access with a Certificate 106 having Soft Expiration 108 may be maintained in active memory for enhanced speed and efficiency. In addition, the computer program 138 for managing network access with a Certificate 106 having Soft Expiration 108 may also be operated within a computer network and may utilize distributed resources.

Moreover, for at least one embodiment, CSE 100 may be summarized as a system for managing certificate based network access based on a Soft Expiration 108 for a Certificate 106. CSE 100 includes an Authentication System 110 structured and arranged to receive from a User 102 by way of a first device 104 having at least one processor, a request 118 for certificate based network access, the request 118 including a Certificate 106 having a Soft Expiration 108. CSE 100 further includes a Validation System 112 having at least one processor and being in communication with the Authentication System 110 and structured and arranged to receive a request for validation of the Certificate 106, the Validation System 112 evaluating the Certificate 106 having the Soft Expiration 108 to a current date by querying a Certificate 106 invalidity source to provide a positive or negative evaluation of the Certificate 106; wherein in response to a positive evaluation of the soft expiration date to the current date the Authentication System 110 permitting Certificate 106 based network access to the user's first device 104 and in response to a negative evaluation of the soft expiration date to the current date the Authentication System 110 blocking at least a portion of network access to the user's first device 104.

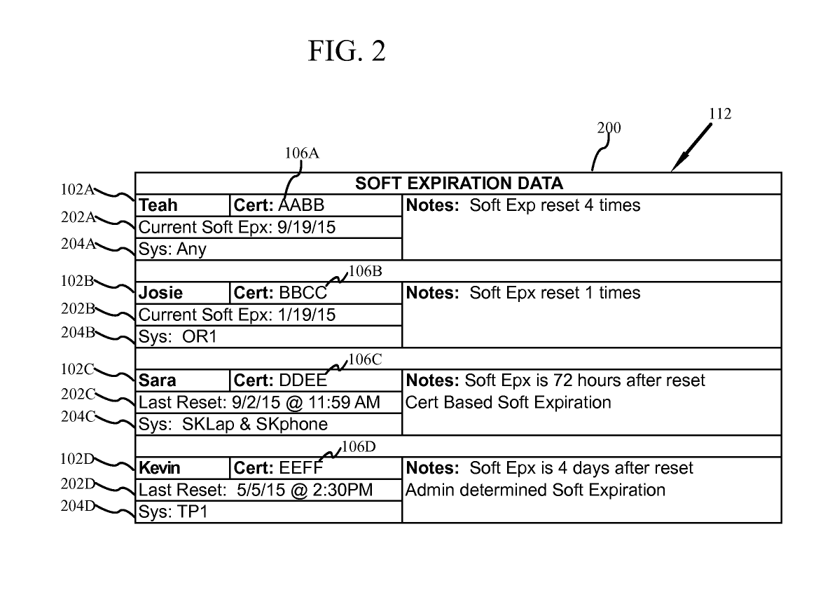

FIG. 2 provides a more detailed conceptual view of the record 114 recording and tracking the Soft Expiration 108. The organization of this record 114 may take many forms, including, but not limited to, a relational database, distributed, or flat file.

For at least one embodiment, as well as ease of illustration and discussion, record 114 is represented at least in part as a table 200. As shown, table 200 presents a series of entries, specifically one for each User 102 known to CSE 100. The nature of the entries associated with each User 102 may vary from User to User depending on the type of Soft Expiration option implemented for each user.

For example, Users 102A and 102B are both shown to have expressly stated Soft Expirations 108/202A and 108/202B. For the purposes of the present example, the current date will be understood and appreciated to be Sep. 10, 2015, and each request for access by the Exemplary Users 102 will have the Soft Expiration 202 evaluated with respect to this exemplary current date of Sep. 10, 2015.

For User 102A the Soft Expiration 202A for Certificate 106A is shown to be Sep. 19, 2015. For User 102B the Soft Expiration 202A for Certificate 106B is shown to be Jan. 19, 2015. Moreover, for User 102A Soft Expiration 202A when evaluated to exemplary current date of Sep. 10, 2015 is valid. Likewise, for User 102B, Soft Expiration 202B when evaluated to exemplary current date of Sep. 10, 2015 is invalid.

For users 102C and 102D, the Soft Expiration 202 is keyed from the date the Soft Expiration 202 was initially set, or more typically reset. For User 102C the Soft Expiration 202C was reset on Sep. 10, 2015 at 11:59 AM. For User 102C the Soft Expiration 202C is shown to be 72 hours after reset. As such, for User 102C the Soft Expiration 202C when evaluated to exemplary current date of Aug. 10, 2015 is valid.

For User 102D the Soft Expiration 202D was reset on May 5, 2015 at 2:30 PM. For User 102D the Soft Expiration 202D is shown to be 4 days after reset. However, as the last reset was in May and the current exemplary date is Aug. 10, 2015, the Soft Expiration 202D for Certificate 106D as held by User 102D is past and therefore invalid.

In addition to the Soft Expiration 202, for at least one embodiment, CSE 100 can also tie the Certificate 106 not just to a specific User 102, but also one or more permitted First Devices 104 associated with the User 102. For at least one embodiment, such association between a First Device 104 and a Certificate 106 is facilitated at least in part by evaluating a device criteria 204 to a Device Trait 142 (see FIG. 1).

In at least one embodiment each First Device 104 has Device Trait 142 corresponding to at least one predefined Device Criteria 204. In varying embodiments and as noted above in the definitions, the Device Trait 142 is understood and appreciated to be a physical aspect of the device and/or a software aspect of the device. More specifically, the Device Trait 142 is an identifiable element of the device, such as, but not limited to, device ID number, device serial number, device type, manufacturer, software version, software ID, an application, digital ID, MAC address, or other similar element that may be used to identify a class of devices, if not uniquely identify one device from another.

Moreover, in at least one embodiment the Device Trait 142 is intended to be unique to each device, such as a device ID number or serial number. For yet another embodiment, the Device Trait 142 is not specifically unique to only one device, but rather serves to identify a class or type of device, i.e., an iPad® 2, an iPad® 3, or an iPhone® 5. In addition, in general the at least one Device Trait 142 is also something that is not easily duplicated from one device to another.

Further, for at least one embodiment the request 118 may also trigger the detection of at least one Characteristic which may be further used to further verify the User 102 and the validity of the request for secure network access based on the Certificate 106 with Soft Expiration 108.

Briefly stated, the Soft Expiration 108 permits validation of a Certificate 106 in a distinctly advantageous way aside from just a traditional indication of validity or invalidity based on the presence or absence of the Certificate 106 in a CRL and/or a review of the Certificate 106 itself.

Moreover, it is understood and appreciated that the Authentication System 110 is for at least one embodiment structured and arranged to interpret a Certificate 106 for a basic evaluation of validity—i.e. a review of the embedded serial number, the person or entity it is assigned to, the issuer, the valid from date, the valid to date, and other data inherent to the Certificate 106 itself. However, the purpose and advantage of CSE 100 is to permit greater degree of control and assessment of validity based on the at least one Soft Expiration 108 that is associated with, but distinct from the Certificate 106.

It should be noted that a system other than CSE 100 would not determine Certificate 106 as invalid because the Soft Expiration 108 as recorded within the notation data fields does not alter the actual encoded expiration period. Moreover, use of the provided data fields for notations within the Certificate 106 to record the Soft Expiration 108 within the Certificate 106 does not alter use or function of the Certificate when and if presented outside of CSE 100, but does permit an advantageous ability to CSE 100 to impose soft expiration periods on Certificates 106 for management of network access without actually revoking and reissuing Certificates 106 in the traditional sense.

For at least one alternative embodiment, the mere possession of a Certificate 106 and ability to provide it with a request 118 is considered sufficient to engage the Validation System 112 for the evaluation of the Certificate 106 based on the Soft Expiration 108.

In response to a positive evaluation by the Validation System 112 validating the Certificate 106 the Authentication System 110 permits access to the User 102. In response to a negative evaluation by the Validation System 112 the Authentication System 110 blocks access to the User 102 and restricts the Certificate 106.

An underlying principle of the present invention as embodied by CSE 100, is that once a Certificate 106 is issued to a User 102, there is and can be a general assumption that the User has vetted him or herself to some degree as a person who can be permitted to use a secured Second System 116, and more specifically the secured certificate based network provided by the Second System 116. Accordingly, gating the use of the Certificate 106 having Soft Expiration for short duration periods based on the Soft Expiration 108 of the Certificate 106 permits management of network access, and does so without requiring a continual practice of issuing new and revoking old certificates.

Moreover, for at least one embodiment, restriction of Certificate 106 initiates an opportunity for the User 102 to renew the Soft Expiration 108 before the Certificate 106 is revoked. It should be expressly understood that the User 106 need not know that his or her access is based on the Certificate having a Soft Expiration date 108. He or she as the User may simply be asked if they would like to enjoy continued access to the Second System 116, perhaps for a fee, in exchange for their re-authentication, or perhaps in exchange for the completion of some task such as a survey.

In other words, for at least one embodiment CSE 100 is structured and arranged to present the option for renewal of the Soft Expiration 108. The renewal of the Soft Expiration 108 may be a multi part test and where the User is provided information that must be returned to CSE 100, or a system or device in communication with CSE 100, or the User 102 may be directed to provide specific information that he or she has previously established. Further, the CSE 100 may request the User to provide a credit card or other form of payment for continued access, re-authentication of the User, or may request that the User complete a survey or otherwise participate in some activity or evaluation before the Soft Expiration 108 is reset.

Moreover, the Soft Expiration 108 reset process may be selected from consisting of, but not limited to, an SMS code for the User 102 for entry upon a specific website within a specific time window, an SMS message to the User 102 requiring a specific reply from the User 102 within a specific time window, an SMS message to the User 102 which requires the User 102 to click on a hyperlink, an email with a verification link, an email with a hyperlink, an email with a code for entry upon a specific website, an email to the User 102 that requires a specific reply within a specific time window, a redirection directly, by SMS or by email to a website which requires the User 102 to complete one or more captcha, redirection of the User to a website which requires entry of additional User information, redirection to a website for payment for continued access, redirection to a website for participation in some activity.

With respect to FIG. 1, the reset of the Soft Expiration 108 is achieved in at least one embodiment by directing the User to a third system 144, which may be the same system to which new Users are directed for the initial process of obtaining a Certificate 106. For at least one embodiment, the third system 144 as the initial system is structured and arranged with specific details regarding each User 102, such as but not limited to social security number, address, birth date, credit card number, personal challenge questions, and/or such other information as may be appropriate for establishing the credentials of a User 102 and providing a Certificate 106. This third system 144 is therefore structured and arranged to challenge a User 102 in some way so as to reset the Soft Expiration 108 associated with his or her Certificate so as to un-restrict his or her Certificate 106.

With respect to the evaluation of the Soft Expiration 108 of the Certificate 106 when presented with a request 118 for access to the Second System 116, it should be understood and appreciated that evaluating the Soft Expiration 108 of the Certificate 106 provides near real time adjustment to the apparent validity of the Certificate 106 without the use of a Certificate Revocation List, i.e. a CRL.

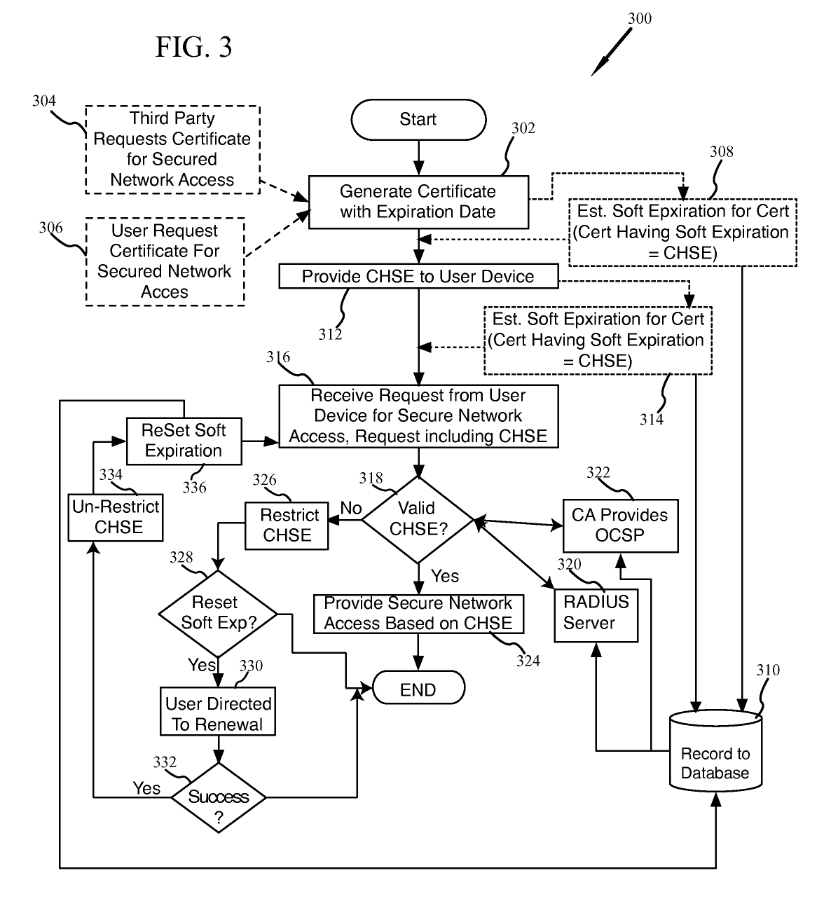

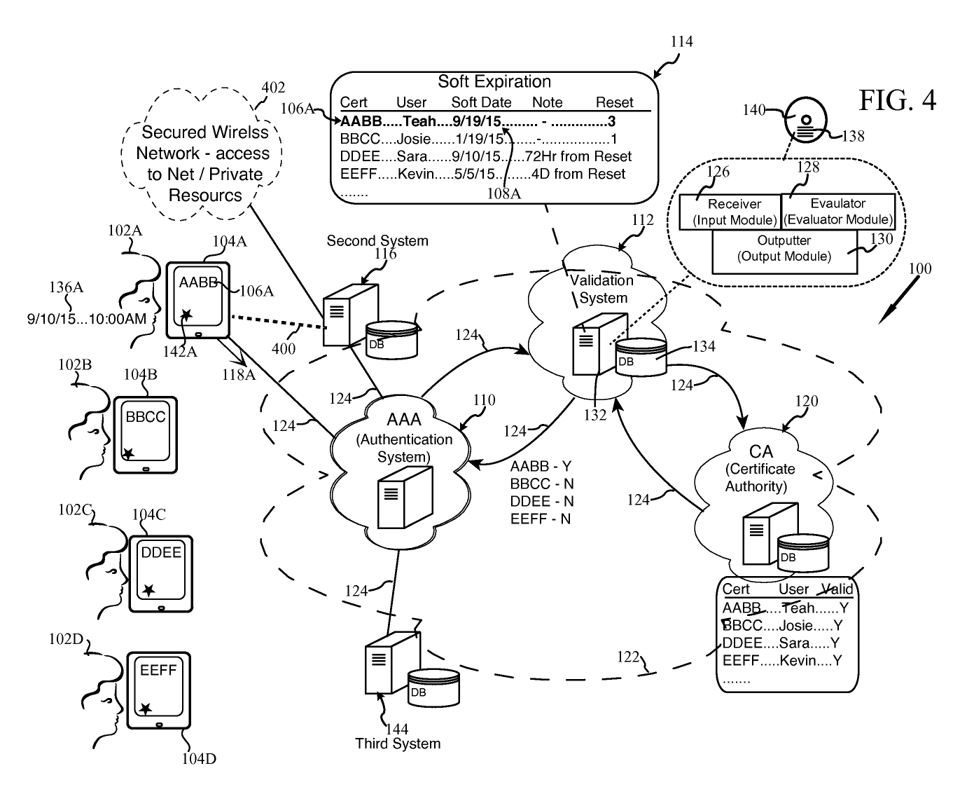

Having described embodiments for CSE 100 as shown with respect to FIGS. 1 and 2, other embodiments relating to varying methods of managing network access based on a Soft Expiration 108 of a Certificate 106 will now be discussed with respect to FIG. 3, in connection with FIGS. 2 and 4-7. More specifically, FIGS. 4-7 are variations based on FIG. 1 each separately illustrating a request 118 for access by users 102A-102D and the resulting process leading to approval or denial. It will be appreciated that the described method need not be performed in the order in which it is herein described, but that this description is merely exemplary of one method of managing network access based on a Soft Expiration 108 of a Certificate 106.

In general, method 300 commences with a Certificate 106 being generated, block 302. For at least one embodiment, such as a conference, hotel, or other setting where managed network access is desired, one or more Certificates 106 may be requested by a third party, block 304. For yet other instances, the generation of a Certificate 106 may be performed in response to a direct request from a User 102, block 306.

For at least one embodiment, the initial Soft Expiration 108 is optionally established when the Certificate 106 is generated, optional block 308. This Soft Expiration 108 is then recoded to a record 114, block 310. Following this, the Certificate 106 having the Soft Expiration is provided to a User 102, or more specifically to the User's First Device 104, block 312.

If the Soft Expiration 108 was not established when the Certificate 106 was issued then for at least one embodiment, the Soft Expiration 108 of the Certificates 106 may be optionally established about contemporaneously with the Certificate 106 being provided to the User(s) 102, optional block 314. Following this optional path, this Soft Expiration 108 is then recoded to a record 114, block 310.

In general, whether a given Certificate 106 was generated in response to a Third Party request or a specific request from the User 102 is immaterial. It is also understood and appreciated that the User 102 does not self generate the Certificate 106. For the present example it is assumed that each exemplary User 102A, 102B, 102C and 102D does in fact have a corresponding Certificate 106A, 106B, 106C and 106D which under normal circumstances would be considered valid.

This is to say that each Certificate 106 was properly generated, has not been revoked, and the current exemplary dates of use as discussed herein are well before the embedded expiration date. Moreover it may be assumed for purposes of example that each of these Certificate 106A, 106B, 106C and 106D has an expiration date set as Jan. 1, 2040, truly a far out date but one that affords a great deal of opportunity for the reset of the Soft Expiration 108 at least once, if not multiple times, and therefore continued management of network access without requiring the overhead to revoke and issue new Certificates 106 again and again to the same Users 102.

It is also of course to be understood that each of these Certificate 106A, 106B, 106C and 106D need not have been generated at the same time, or issued to their respective Users 102A, 102B, 102C and 102D at the same time, rather each may have been issued as each User 102 has been added to the CSE 100. As noted above, if a Soft Expiration 108 has not yet been established, that Soft Expiration 108 may be established about contemporaneously with the Certificate 106 being provided to the User 102.

The Soft Expiration 108 of each Certificate 106 may be implemented in a number of flexible and advantageous ways. For at least one embodiment, the Soft Expiration may be determined by simply selecting some date in the future that is believed to be adequate in providing secured network access for an appropriate duration. This may be determined by how many days the User is willing to pay for access, how many days the current assignment is expected to last, how many days the current stay or involvement with a resort or convention is expected to last, or some other metric by which a not too distant future date is

For exemplary User 102A, Teah who's Certificate 106A is AABB and who is on vacation at a resort providing secured wireless network access to resort guests during their stay, table 200 shows that the Soft Expiration date is 9/19/2015, her departure date, which is understood to be nine days from the exemplary current date of Sep. 10, 2015. Table 200 also notes that the Soft Expiration date has been reset 4 times in the past. An additional note may also exist indicating that although Teah is visiting now in September, she typically visits in January.

For the present example, exemplary User 102B, Josie who's Certificate 106B is BBCC, is a contractor who is currently on long-term assignment. As such her Certificate 106B has a Soft Expiration 108B date set for Jan. 19, 2015 that corresponds to the end of her last contract. Given the nature of the assignment, she has now returned again and will be engaged from September 2015 through Jan. 19, 2016. Further, it is very likely that Josie will return in September of 2016 for another 4 month contract. Use of CSE 100 and method 300 advantageously permits certificate based secure network access when required for the contract, and prevents access between contract assignments, all without requiring a new Certificate 106 to be requested, generated, installed and managed.

Exemplary Users 102C, Sara and 102D, Kevin are slightly different. For these Users, the Soft Expiration 108 is not arbitrarily set to a future date based on an event such as duration of stay, length of project, or pre-payment of secure network access up to a given date. For these Users the Soft Expiration 108 is established as a set time period running from when the Soft Expiration 108 was set/reset.

In addition, for User 102C, Sara, who's Certificate 106C is DDEE, this run time for validity is determined directly from the Certificate 106C itself. Moreover in accordance with at least one embodiment of CSE 100 and method 300, one of the data fields incorporated as part of Certificate 106C specifies the length of time for the Certificate 106D to be accepted as valid after the Soft Expiration reset. As this value is encoded to the Certificate 106D itself, it cannot be changed.

In contrast, User 102D, Kevin, who's Certificate 106D is EEFF also has a Soft Expiration 108 that is set to run for an interval after the Soft Expiration is reset, however in this case this duration is subject to review and revision by an administrator. Moreover, although table 200 currently indicates that the Soft Expiration will extend for 4 days, this may be changed—say to 2 days, 10 days, or some other desired value as deemed appropriate by the administrator.

Possessing a Certificate 106, the users 102 of CSE 100 are set to request access and to receive access, or so each may believe. CSE 100 now receives a request for network access from the User 102, the request 118 providing the Certificate 106 having the Soft Expiration, block 316. For at least one embodiment, the request 118 may also provide or otherwise trigger the identification of a Device Trait 142, which as discussed below may be incorporated as an element in the evaluation of the request for secure network access upon the Second System 116. In addition, for at least one embodiment the request 118 may also provide the Characteristic 136, such as the date and time of the request 118, which may also be incorporated in the evaluation process.

In response to a positive evaluation of the Soft Expiration 108 of the Certificate 106 to the current date, decision 318, the Certificate 106 is validated and certificate based network access is provided to First Device 104. Conversely, in response to a negative evaluation of the Soft Expiration 108 of the Certificate 106 to the current date, decision 318, the Certificate 106 is restricted and at least a portion of network access is blocked to the First Device 104.

For at least one embodiment, this partial blocking is an entire blocking of any and all access to the secured system, i.e., Second System 116, and is instead a re-direction to a third system that may be used to reset the Soft Expiration 108. For at least one alternative embodiment, this partial blocking of network access permits only limited access to a specific webpage(s) of the secured site that may be used to reset the Soft Expiration 108.

For either option, the action to reset may be any of those as noted above, such as but not limited to: re-direction to a subscription webpage to pay for additional access, a re-authentication website to re-authenticate the User; a webpage for survey, questionnaire, or other task completion; or such other webpage as may be desired for the User to visit with and provide some form of payment or interaction therewith so as to reset the Soft Expiration 108.

Variations in how management of network access based on a Certificate 106 with Soft Expiration 108 may be more fully appreciated with respect to the following examples.

### Example No. 1—Access Request Prior to Soft Expiration

Returning to FIG. 3 and method 300, in the exemplary case of User 102A, Teah, as shown in FIG. 4, the exemplary access request 118A, block 316, is being made on Sep. 10, 2015. It is also noted that in Table 200, there is a Device Criteria 204A noted as “ANY”, which is to say that User 102A may use the Certificate 106A on any First Device 104A—a laptop, a smart phone, both, etc. . . . . Indeed, for at least one embodiment, User 102A may use Certificate 106A on multiple devices simultaneously.

Method 300 moves to evaluating the Soft Expiration 202A of the Certificate 106A, decision 318. Although the evaluation may be performed by the Authentication System 110, for ease of illustration and discussion the evaluation is generally performed by the Validation System 112. For at least one embodiment, to evaluate the Soft Expiration 202A, the Validation System 112 may be, or incorporate a RADIUS server, block 320. Optionally, the Validation System 112 may query an enhanced CA providing an OCSP (Online Certificate Status Protocol), block 322.

In either case, the status of the Soft Expiration 108 is determined at least in part by consulting the record 114/310. Moreover, to evaluate the Certificate 106 having Soft Expiration 108, a certificate invalidity source, such as record 114 and/or table 200 is queried as provided by a database, the Validation System 112, an enhanced Certificate Authority 120, or other system.

For User 102A, Teah, as the exemplary current date is Sep. 10, 2015 and therefore before the Soft Expiration 202A shown as Sep. 19, 2015, the evaluation of the Soft Expiration 202A is positive, and First Device 104A is provided with secure network access in the form of communications link 400 directly to the Second System 116, based on the Certificate having Soft Expiration 108, block 324.

As a result of this direct and secure communication link 400 to Second System 116, Teah now is permitted access and use of the resources 402, provided by Second System 116. Again, absent a positive evaluation of the Certificate 106A with Soft Expiration 108, Teah would not be permitted to access these resources 402 by way of Second System 116.

### Example No. 2—Access Request after Soft Expiration

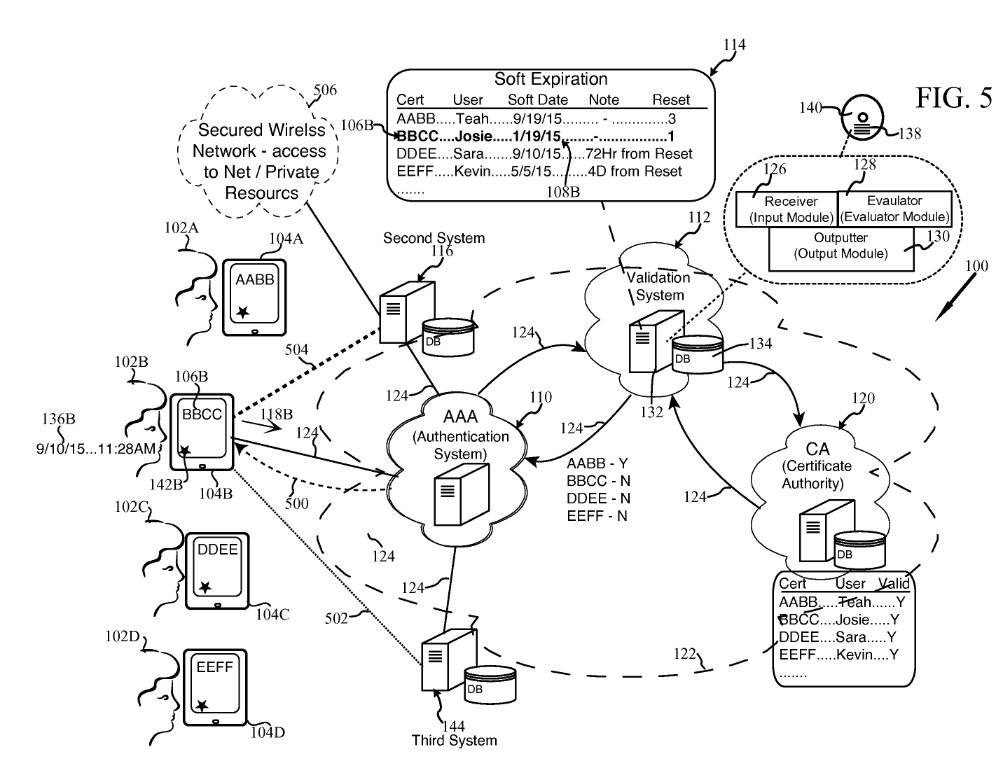

In the exemplary case of User 102B, Josie, as shown in FIG. 5, the flow of method 300 is slightly different. As shown in table 200, the Soft Expiration date for Certificate 106B is currently shown to be Jan. 19, 2015. Upon receipt of the request 118B from User 102B, block 316, method 300 moves to evaluate the Soft Expiration, decision 318. In this case as the Soft Expiration 202B is shown in table 200 to be Jan. 19, 2015 and the exemplary current date is Sep. 10, 2015, the evaluation is negative and the Certificate 106 is restricted, block 326.

In other words, CSE 100 de-activates Certificate 106B—which is to say that it has not been revoked and its status with the Certificate Authority 120 is unchanged. However, within CSE 100 the Certificate 106B is in a state of suspension.

Method 300 moves to determining if the Soft Expiration 202B should be reset, decision 328. As noted above, a reset of the Soft Expiration 108/202B may be performed in response to one or more actions on the part of the User 102/102B, such as paying for additional access or interacting with the webpage to re-authenticate him or herself.

With respect to exemplary User 102B it is also worth noting that table 200 notes that Device Criteria 204B is for “laptop”. If First Device 104B provides a Device Trait 142B indicating that it is a tablet or smart phone and not a laptop, the Soft Expiration 202B may be evaluated as invalid based on the request 118 having been provided by an unauthorized device.

For the purposes of the present example, it is assumed that resetting of the Soft Expiration 202B is desired for Certificate 106B, so the First Device 104B is directed to a renewal Website, block 330, such as may be provided by third system 144. In varying embodiment, this redirection may be automatic, such as by CSE 100 redirecting the User Device 102B to the Third System 144 by communications link 400, or achieved by CSE 100 sending a text message 500 to First Device 104B that includes a re-direction link to Third System 144.

For the present example of User 102B being a contractor, the use of a text message may be desirable as the text message affords CSE 100 the opportunity to provide User 102B with an authorization code, i.e. 28088, that may be in turn provided by First Device 102B to the Third System 144 to reset the Soft Expiration 202B. Receiving the text message 500, User 102B accesses the Third System 144 via communications link 502, such as by a web browser and provides the received code, i.e., code 28088, block 330. Of course, in absence of a text message, User 102B may provide other identification upon connection to Third System 144 to achieve the reset of the Soft Expiration 202B.

If User 106B is successful with the Reset of the Soft Expiration 202B of Certificate 106B, decision 332, the Restriction of CHSE is removed, block 334, and the Soft Expiration Record 114/310 is updated, block 336. User 102B then sends his request 118B for access once again, block 316, and this time the Soft Expiration date will be evaluated positively, resulting in User 102B being provide with secure communication link 504 to Second System 116.

As a result of this direct and secure communication link 504 to Second System 116, Josie now is permitted access and use of the resources 506, provided by Second System 116. Again, absent a positive evaluation of the Certificate 106B with Soft Expiration 108/202B, Josie would not be permitted to access these resources 506 by way of Second System 116.

### Example No. 3—Soft Expiration Term After Reset Specified by Certificate

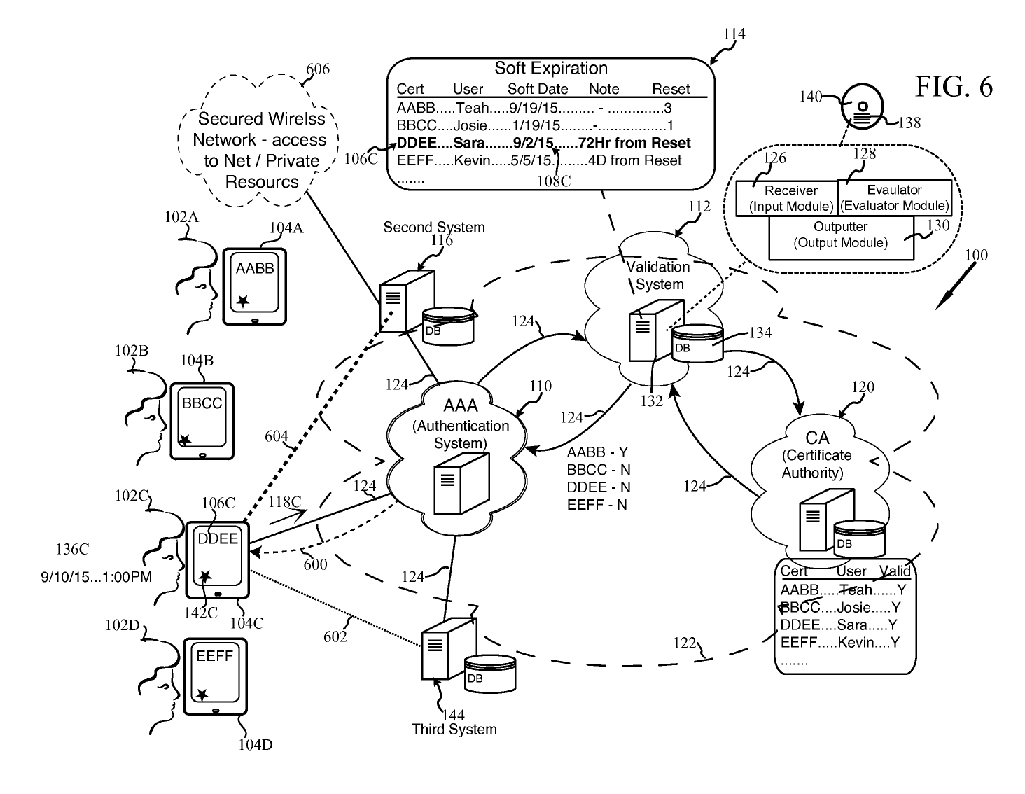

User 102C, Sara, having Certificate 106C as DDEE, presents a slightly different example for how CSE 100 may be implemented as shown in FIG. 6. Whereas for Users 102A and 102B the Soft Expiration 108 was expressed as a specific date in the future, for User 102C, Sara, the Soft Expiration 108 is established based on when the Soft Expiration 108 was last reset. Encoded as an element of her Certificate 106C is a data element specifying that the Soft Expiration 108 for her Certificate should extend for 72 hours after being reset. For example the optional Extensions field of an X.509 certificate may be used to encode the duration setting. It is further understood and appreciated that encoding or embedding the Soft Expiration 108/202C within Certificate 106C, such as in the certificate purpose data field does not alter the Certificate 106, rather the ability to recognize the Soft Expiration 108 within the Certificate 106 is an advantageous feature of CSE 100.

When User 102C arrives to request secured network access to Second System 116, method 300 will progress as above and determine that her Certificate 106C with Soft Expiration is invalid if it has been more than 72 hours since the Soft Expiration was reset.

As Certificate 106C is shown in table 200 to have a Soft Expiration 202C of 9/2/2015, she is just past the Soft Expiration. Accordingly, as shown in FIG. 6 she will be directed to third system 144 to reset the Soft Expiration 202C of her Certificate 106C. In this case, this redirection is by hyper link 600, that redirects User 102C to Third System 144 by communications link 602.

For this example, it may be presumed that Sara's Certificate 106C is based not on a stay with a resort, hotel, or conference, or as part of an employment contract, but simply based on payment for network access.

For each payment of funds at the start of her desired period of access, she is provided with 72 hours of secure, certificate based network access commencing from the time she provides payment to the third system 144 and resets the Soft Expiration 202C of her Certificate 106C. As shown in table 200 the Device Criteria noted for her account also specifies that her Certificate 106C may be used with a laptop—identified as SKLap, and a smart phone—identified as SKphone.

When Sara resets the Soft Expiration 202C for her Certificate 106C, the database is updated to reflect that the Soft Expiration is 72 hours from the transaction of renewal. Sara is then provided with secure communication link 604 to Second System 116.

As a result of this direct and secure communication link 604 to Second System 116, Sara now is permitted access and use of the resources 606, provided by Second System 116. Again, absent a positive evaluation of the Certificate 106C with Soft Expiration 202C, Sara would not be permitted to access these resources 606 by way of Second System 116.

At the expiration of that 72 hour period, the Soft Expiration for her Certificate 106C will once again be evaluated in the negative and she will once again have the opportunity to reset.

### Example No. 4—Soft Expiration Term after Reset Specified by Admin

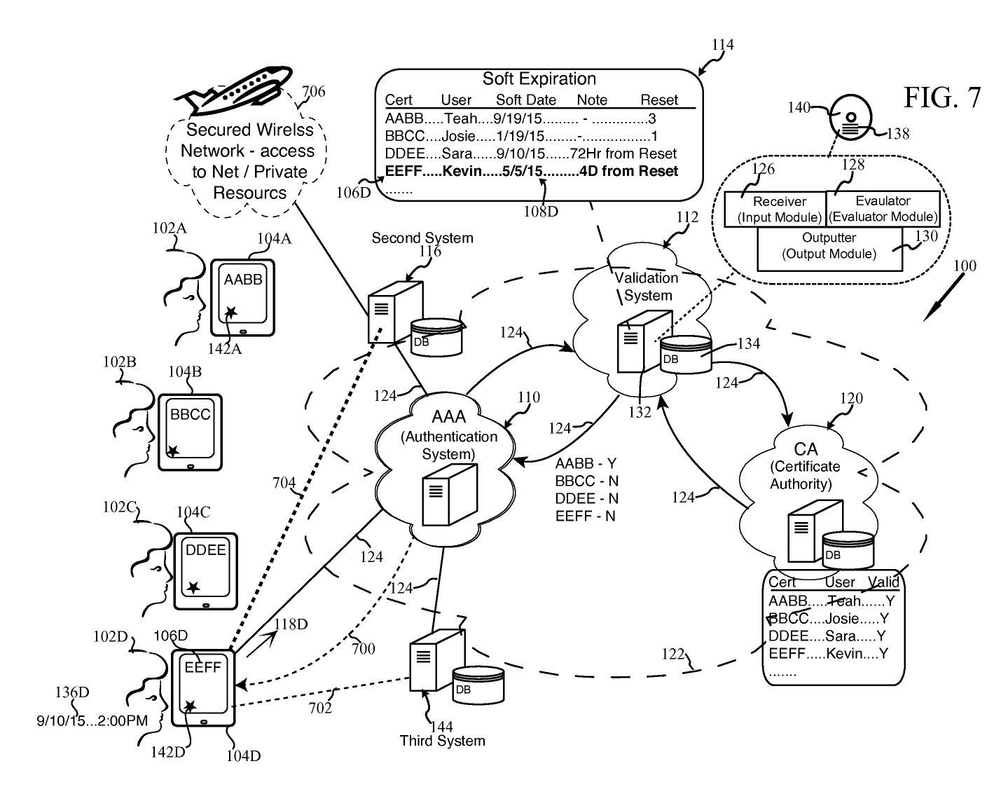

The example case of User 102D, Kevin, having Certificate 106D is slightly different still and is shown in FIG. 7. For User 102D, as with User 102C, the Soft Expiration 202D is reset based on a specific time interval from the point of reset. However, in contrast to User 102C, this interval for User 102D is not determined from the Certificate 106D but rather is an element specified by an administrator of the Soft Expiration record 114.

As is evident from table 200, Example User 102D, Kevin, has not attempted to use his Certificate 106D in quite some time. Upon his request for secure network access, block 316, his Certificate 106D will be deemed invalid, decision 318 and restricted block 326.

In this example, User 102D, Kevin, enjoys his Certificate 106D for secured network access upon Second System 116 as he is a frequent flyer with status on a popular airline and the Second System 116 is a faster and more desirable secure system providing free email and web browsing, as well as premium video content—but only to those Users 102 who have a Certificate 106 with a Soft Expiration 108 that is valid.

For this example, a period of 4 days has been selected by the administrator of table 200 as Kevin's trips usually fall within 3 to 4 days. Given his status with this airline, to reset his Soft Expiration 108/202D, Kevin is sent an email, 700, which includes a hyperlink to a Webpage he accesses via communications link 702, where is requested to complete a short survey about his experiences with the airline. Moreover, in exchange for his sharing his views as a frequent traveler on what the Airline did both good and bad, he is rewarded with premium certificate based secure access to the Second System 116.

In addition, for this example, Kevin may access the Authentication System 110 before departing for the airport, perhaps as part of his check in process. As such he receives the email 700 and may connect to the webpage via communications link 702 and complete his survey such that his Certificate 106D with Soft Expiration 202D is reset and ready to go when he board the aircraft.

Upon boarding, Kevin is in proximity to the Secured Second System 116 and his Certificate 106D is automatically provided, evaluated and deemed valid, and he is then provided with secure communication link 704 to Second System 116, in this example the secure aircraft WiFi.

As a result of this direct and secure communication link 704 to Second System 116, Kevin now is permitted access and use of the resources 706, provided by Second System 116. Again, absent a positive evaluation of the Certificate 706D with Soft Expiration 202D, Kevin would not be permitted to access these resources 706 by way of Second System 116.

It should be expressly noted that in this example, Kevin has reset his Soft Expiration 108/202D before even attempting to access the Second System 116. Had he waited till he was in the presence of the aircraft WiFi system such as is commonly available within the terminal when proximate to the gate, in an optional setting he again would have been afforded the opportunity to reset his Soft Expiration 202D for his Certificate 106D.

Moreover, embodiments of CSE 100 and method 300 permit highly advantageous control of Certificates 106 and how they are used. An authorized User 102 may certainly receive a Certificate 106 with Soft Expiration 108 for access that is viable for his or her First Device 104 during a project; his or her First Device 104 during a convention, hotel, resort stay, or air travel; or other event of potentially short duration. In varying embodiments the Certificate 106 may also be limited to specific devices, or open ended to any devices.

With respect to the above examples, it should also be noted that if decision Reset Soft Expiration is “No,” decision 328, or if the renewal is not successful for whatever reason, decision 332, method 300 ends. In either case the Certificate 106 with Soft Expiration 108 has been restricted, but it has not been permanently revoked. Revocation of the Certificate may be implanted in some embodiments, but it is not necessary in all. For example, just because a User opted not to renew his or her Certificate 106 with Soft Expiration 108 in one instance does not suggest that they may not wish to renew at some further point. Because the Certificate 106 with Soft Expiration 108 has not been permanently and/or revoked, such as by seeing the Certificate 106 included on a CRL, it is still valid and therefore may be un-revoked at any future point prior to the actual expiration date.

For administrative ease, the life span of the issued Certificate 106 with Soft Expiration 108 may also be quite great—measured in multiple years for example, yet the granularity of the Soft Expiration 108, as well as other elements such as evaluating Device Traits 142, permit advantageous control of access and perceived validity of one or more Certificates 106 without reliance upon a traditional CRL.

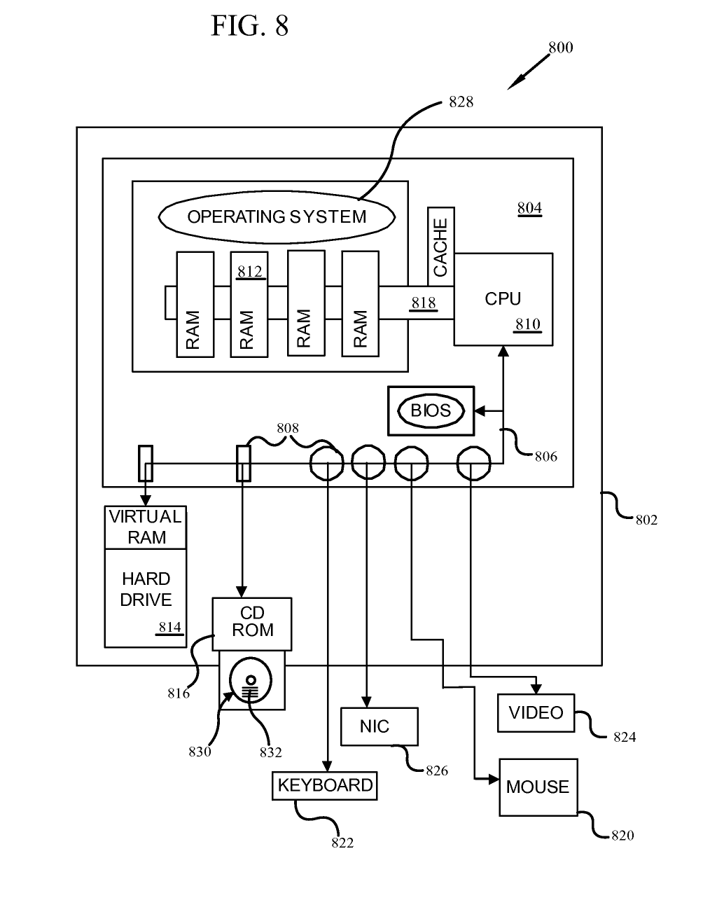

With respect to the above description of the system and method for managing network access with a Certificate 106 having Soft Expiration 108, it is understood and appreciated that the method may be rendered in a variety of different forms of code and instruction as may be used for different computer systems and environments. To expand upon the initial suggestion of the First Device 104, Authentication System 110, Validation System 112, Second System 116, Certificate Authority 120, and Third System 144 being computer systems adapted to their specific roles, FIG. 8 is a high level block diagram of an exemplary computer system 800 such as may be provided for one or more of the elements comprising the First Device 104, Authentication System 110, Validation System 112, Second System 116, Certificate Authority 120, and Third System 144 whether provided as distinct individual systems or integrated together in one or more computer systems.

Computer system 800 has a case 802, enclosing a main board 804. The main board 804 has a system bus 806, connection ports 808, a processing unit, such as Central Processing Unit (CPU) 810 with at least one microprocessor (not shown) and a memory storage device, such as main memory 812, hard drive 814 and CD/DVD ROM drive 816.

Memory bus 818 couples main memory 812 to the CPU 810. A system bus 806 couples the hard disc drive 814, CD/DVD ROM drive 816 and connection ports 808 to the CPU 810. Multiple input devices may be provided, such as, for example, a mouse 820 and keyboard 822. Multiple output devices may also be provided, such as, for example, a video monitor 824 and a printer (not shown). As computer system 800 is intended to be interconnected with other computer systems in the CSE 100 a combined input/output device such as at least one network interface card, or NIC 826 is also provided.

Computer system 800 may be a commercially available system, such as a desktop workstation unit provided by IBM, Dell Computers, Gateway, Apple, or other computer system provider. Computer system 800 may also be a networked computer system, wherein memory storage components such as hard drive 814, additional CPUs 810 and output devices such as printers are provided by physically separate computer systems commonly connected together in the network.

Those skilled in the art will understand and appreciate that the physical composition of components and component interconnections are comprised by the computer system 800, and select a computer system 800 suitable for one or more of the computer systems incorporated in the formation and operation of CSE 100.

When computer system 800 is activated, preferably an operating system 828 will load into main memory 812 as part of the boot strap startup sequence and ready the computer system 800 for operation. At the simplest level, and in the most general sense, the tasks of an operating system fall into specific categories, such as, process management, device management (including application and User interface management) and memory management, for example. The form of the computer-readable medium 830 and language of the program 832 are understood to be appropriate for and functionally cooperate with the computer system 800.

Moreover, variations of computer system 800 may be adapted to provide the physical elements of one or more components comprising each First Device 104, Authentication System 110, Validation System 112, Second System 116, Certificate Authority 120, and Third System 144 the switches, routers and such other components as may be desired and appropriate for the methods and systems of managing network access based on a Certificate 106 having Soft Expiration 108.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed is:

1. A method of managing network access based on a soft expiration date for a Certificate comprising:
generating, by a Certificate generation system having a processor, a Certificate having an embedded expiration date;
establishing for the Certificate a Soft Expiration Date occurring before the embedded expiration date;
providing the Certificate having the Soft Expiration Date to a User Device having a processor, the User Device distinct from the Certificate generation system, the certificate for certificate based network access on a secured wireless network;
receiving by an authentication device, a request for wireless network access upon the secured wireless network from the user device, the request providing the Certificate having the Soft Expiration Date;
evaluating the soft expiration date of the Certificate having the Soft Expiration date to a current date;
in response to a positive evaluation of the soft expiration date to the current date, validating the Certificate having the Soft Expiration Date provided in the request and permitting certificate based network access to the user device; and
in response to a negative evaluation of the soft expiration date to the current date, restricting the Certificate having the Soft Expiration Date provided with the request and blocking at least a portion of network access to the user device.

2. The method of claim 1, wherein a positive evaluation of the soft expiration date includes evaluating the soft expiration date as equal to or greater than the current date.

3. The method of claim 1, wherein a positive evaluation of the soft expiration date includes evaluating the soft expiration date as greater than the current date.

4. The method of claim 1, wherein establishing the Soft Expiration Date further comprises specifying a future calendar date.

5. The method of claim 1, wherein establishing the Soft Expiration Date further comprises specifying a time period.

6. The method of claim 1, wherein blocking at least a portion of the network access includes directing the User Device to access a subscription webpage to pay for additional access and reset the soft expiration date.

7. The method of claim 1, wherein blocking at least a portion of the network access includes directing the User Device to access a renewal webpage to re-authenticate the User and reset the soft expiration date.

8. The method of claim 1, wherein evaluation of the soft expiration date permits network access management without reissuing a new certificate.

9. The method of claim 1, wherein upon the negative evaluation of the soft expiration date to the current date, the Certificate having the Soft Expiration Date is treated as invalid.

10. The method of claim 1, wherein evaluating the soft expiration date includes querying a Certificate validity source.

11. The method of claim 10, wherein the certificate validity source is selected from the group consisting of: an OCSP, a CRL, a database.

12. The method of claim 1, wherein validity of the Certificate having the Soft Expiration Date is changed by reporting via a Certificate Authority in communication with the authentication device an invalid state for the Certificate having the Soft Expiration Date upon the Soft Expiration Date.

13. The method of claim 1, wherein validity of the Certificate having the Soft Expiration Date is changed by reporting via a RADIUS Server in communication with the authentication device an invalid state for the Certificate having the Soft Expiration Date upon the Soft Expiration Date.

14. The method of claim 1, wherein restricting the Certificate initiates an opportunity for the user to re-authenticate him or herself before revoking the Certificate.

15. The method of claim 14, wherein the opportunity for re-authentication is selected from the group consisting of: a Short Message Service (“SMS”) code to the user for entry upon a website, an SMS message which requires a specific SMS reply, an SMS message which requires the user to click a hyperlink, an SMS message which requires the user to click a hyperlink, an email with verification link, an email with a code for entry upon a website, an email that requires a reply, redirection to a website which requires completion of a captcha, and redirection to a website which requires entry of additional information.

16. The method of claim 1, wherein the method is provided on a non-transitory machine readable medium as a computer program comprising instructions which when executed by a computer system having at least one processor performs the steps of providing a Certificate having soft expiration for network access.

17. A system for managing certificate based network access based on a soft expiration date for a Certificate comprising:
an authentication hardware system structured and arranged to receive from a User by way of a first device having at least one processor, a request for certificate based network access, the request including a Certificate having a Soft Expiration Date;
a validation hardware system having at least one processor and being in communication with the authentication hardware system and structured and arranged to receive a request for validation of the Certificate, the validation hardware system evaluating the Certificate having the Soft Expiration Date to a current date by querying a Certificate invalidity source to provide a positive or negative evaluation of the Certificate;
wherein in response to a positive evaluation of the soft expiration date to the current date the authentication hardware system permitting certificate based network access to the user's first device and in response to a negative evaluation of the soft expiration date to the current date the authentication system blocking at least a portion of network access to the user device.

18. The system of claim 17, further including:
a certificate generation hardware system having at least one processor, structured and arranged to generate the Certificate for Certificate based network access, the certificate having an embedded expiration date;
a soft expiration setting hardware system having at least one processor, structured and arranged to establish for the Certificate a Soft Expiration Date occurring before the embedded expiration date, the soft expiration setting system further providing the Certificate having the Soft Expiration Date to a User Device having a processor, the User Device distinct from the Certificate generation system, the certificate for certificate based network access on a secured wireless network;

19. The system of claim 17, wherein the validation system is a component of the authentication system.

20. The system of claim 17, wherein the validation system is a component of a Certificate authority responsible for the Certificate.

21. The system of claim 17, wherein the validation system is disposed between the authentication system and a Certificate authority responsible for the Certificate.

22. The system of claim 17, wherein blocking at least a portion of the network access includes permitting the User Device to access a subscription webpage to pay for additional access and a reset of the soft expiration date.

23. The system of claim 17, wherein a positive evaluation of the soft expiration date includes evaluating the soft expiration date as equal to or greater than the current date.

24. The system of claim 17, wherein a positive evaluation of the soft expiration date includes evaluating the soft expiration date as greater than the current date.

25. The system of claim 17, wherein evaluation of the soft expiration date permits network access management without reissuing a new certificate.

26. The system of claim 17, wherein upon the negative evaluation of the soft expiration date to the current date, the Certificate having the Soft Expiration Date is treated as invalid.

27. The method of claim 17, wherein the certificate validity source is selected from the group consisting of: an OCSP, a CRL, a database.

28. The system of claim 17, wherein validity of the Certificate having the Soft Expiration Date is changed by reporting to a Certificate Authority in communication with the authentication device an invalid state for the Certificate having the Soft Expiration Date upon the Soft Expiration Date.

29. The system of claim 17, wherein validity of the Certificate having the Soft Expiration Date is changed by reporting to a RADIUS Server in communication with the authentication device an invalid state for the Certificate having the Soft Expiration Date upon the Soft Expiration Date.

30. The system of claim 17, wherein restricting the Certificate initiates an opportunity for the user to re-authenticate him or herself before revoking the Certificate.

31. The method of claim 30, wherein the opportunity for re-authentication is selected from the group consisting of: a Short Message Service (“SMS”) code to the user for entry upon a website, an SMS message which requires a specific SMS reply, an email with verification link, an email with a code for entry upon a website, an email that requires a reply, redirection to a website which requires completion of a captcha, and redirection to a website which requires entry of additional information.

32. A non-transitory machine readable medium on which is stored a computer program for managing certificate based network access on a soft expiration date for a Certificate provided to a user, the computer program comprising instructions which when executed by a computer system having at least one processor performs the steps of:
receiving by an authentication device, a request for wireless network access upon the secured wireless network from the user device, the request providing the Certificate having a Soft Expiration Date, the Certificate having the Soft Expiration Date previously provided to the user device by a certificate generation system other than the user device, the Soft Expiration Date of the Certificate established to occur before an embedded expiration date within the Certificate having the Soft Expiration Date.
evaluating the soft expiration date of the Certificate having the Soft Expiration date to a current date;
in response to a positive evaluation of the soft expiration date to the current date, validating the Certificate having the Soft Expiration Date provided in the request and permitting certificate based network access to the user device; and
in response to a negative evaluation of the soft expiration date to the current date, restricting the Certificate having the Soft Expiration Date provided with the request and blocking at least a portion of network access to the user device.

33. The non-transitory machine readable medium of claim 32, wherein a positive evaluation of the soft expiration date includes evaluating the soft expiration date as equal to or greater than the current date.

34. The non-transitory machine readable medium of claim 32, wherein a positive evaluation of the soft expiration date includes evaluating the soft expiration date as greater than the current date.

35. The non-transitory machine readable medium of claim 32, wherein establishing the Soft Expiration Date further comprises specifying a future calendar date.

36. The non-transitory machine readable medium of claim 32, wherein establishing the Soft Expiration Date further comprises specifying a time period.

37. The non-transitory machine readable medium of claim 32, wherein blocking at least a portion of the network access includes directing the User Device to access a subscription webpage to pay for additional access and reset the soft expiration date.

38. The non-transitory machine readable medium of claim 32, wherein blocking at least a portion of the network access includes directing the User Device to access a renewal webpage to re-authenticate the User and reset the soft expiration date.

39. The non-transitory machine readable medium of claim 32, wherein evaluation of the soft expiration date permits network access management without reissuing a new certificate.

40. The non-transitory machine readable medium of claim 32, wherein upon the negative evaluation of the soft expiration date to the current date, the Certificate having the Soft Expiration Date is treated as invalid.

41. The non-transitory machine readable medium of claim 32, wherein evaluating the soft expiration date includes querying a Certificate validity source.

42. The non-transitory machine readable medium of claim 41, wherein the certificate validity source is selected from the group consisting of: an OCSP, a CRL, a database.

43. A non-transitory machine readable medium on which is stored a computer program comprising instructions to adapt a computer system having at least one processor to provide certificate based network access based on a Certificate having a soft expiration date previously provided to a user comprising:
a receiver module operatively associated with an input device for receiving a request for certificate based network access from a user by way of a first device having at least one processor, the request providing the Certificate having the Soft Expiration Date previously provided to the user device by a certificate generation system other than the user device, the Soft Expiration Date of the Certificate established to occur before an embedded expiration date within the Certificate having the Soft Expiration Date;
an evaluation module for evaluating the soft expiration date of the Certificate to provide a positive or negative evaluation of the request;
in response to a positive evaluation of the soft expiration date to the current date, validating the Certificate having the Soft Expiration Date provided in the request and permitting certificate based network access to the user device; and
in response to a negative evaluation of the soft expiration date to the current date, restricting the Certificate having the Soft Expiration Date provided with the request and blocking at least a portion of network access to the user device.

44. The non-transitory machine readable medium of claim 43, wherein a positive evaluation of the soft expiration date includes evaluating the soft expiration date as equal to or greater than the current date.

45. The non-transitory machine readable medium of claim 43, wherein a positive evaluation of the soft expiration date includes evaluating the soft expiration date as greater than the current date.

46. The non-transitory machine readable medium of claim 43, wherein establishing the Soft Expiration Date further comprises specifying a future calendar date.

47. The non-transitory machine readable medium of claim 43, wherein establishing the Soft Expiration Date further comprises specifying a time period.

48. The non-transitory machine readable medium of claim 43, wherein blocking at least a portion of the network access includes directing the User Device to access a subscription webpage to pay for additional access and reset the soft expiration date.

49. The non-transitory machine readable medium of claim 43, wherein blocking at least a portion of the network access includes directing the User Device to access a renewal webpage to re-authenticate the User and reset the soft expiration date.

50. The non-transitory machine readable medium of claim 43, wherein evaluation of the soft expiration date permits network access management without reissuing a new certificate.

51. The non-transitory machine readable medium of claim 43, wherein upon the negative evaluation of the soft expiration date to the current date, the Certificate having the Soft Expiration Date is treated as invalid.

52. The non-transitory machine readable medium of claim 43, wherein evaluating the soft expiration date includes querying a Certificate validity source.

53. The non-transitory machine readable medium of claim 52, wherein the certificate validity source is selected from the group consisting of: an OCSP, a CRL, a database.
